(19) United States
(12) Patent Application Publication
(10) Pub. No.: US 2010/0190969 A1
(43) Pub. Date: Jul. 29, 2010

(54) NON-NATURALLY OCCURRING CARBOHYDRATE-BASED FIBROUS ELEMENTS AND METHODS FOR MAKING SAME

(76) Inventor: Dean Van Phan, West Chester, OH (US)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/691,147

(22) Filed: Jan. 21, 2010

Related U.S. Application Data
(60) Provisional application No. 61/147,554, filed on Jan. 27, 2009.

(51) Int. Cl. C08B 37/00; C08B 15/00; C08B 31/00; C08B 37/08

(52) U.S. Cl. 536/18.3; 536/1.11; 536/56; 536/102; 536/20; 536/120; 536/124; 536/4.1; 536/123.1

(57) ABSTRACT

Non-naturally occurring carbohydrate-based fibrous elements and more particularly, non-naturally occurring carbohydrate-based fibrous elements having a macrostructure and a microstructure wherein the microstructure is visible when wet and methods for making same are provided.

### CROSS REFERENCE TO RELATED APPLICATION

This application claims the benefit of U.S. Provisional Application No. 61/147,554, filed Jan. 27, 2009.

### FIELD OF THE INVENTION

The present invention relates to non-naturally occurring carbohydrate-based fibrous elements and more particularly to non-naturally occurring carbohydrate-based fibrous elements comprising a macrostructure and a microstructure wherein the microstructure is visible when wet and methods for making same.

### BACKGROUND OF THE INVENTION

Non-naturally occurring carbohydrate-based fibrous elements are known in the art. However, such known fibrous elements have not comprised a macrostructure and a microstructure wherein the microstructure is visible when wet and have thus not exhibited wet tensile properties suitable for materials used in water contacting products.

Accordingly, as formulators continue to try to find non-polyolefin based materials for use in products, there is a need for materials that exhibit certain wet tensile properties, especially non-naturally occurring carbohydrate-based materials, such as materials used in fibrous elements.

### SUMMARY OF THE INVENTION

The present invention fulfills the need described above by providing a non-naturally occurring carbohydrate-based fibrous elements that comprise a macrostructure and a microstructure wherein the microstructure is visible when wet exhibit improved wet tensile when compared to non-naturally occurring carbohydrate-based fibrous elements that do not comprise a macrostructure and a microstructure wherein the microstructure is visible when wet, especially when the carbohydrate-based fibrous element comprises a starch derivative.

In one example of the present invention, a non-naturally occurring, wettable carbohydrate-based fibrous element comprising a macrostructure and a microstructure, wherein the microstructure is visible when wet as determined by the Microstructure Detection Test Method is provided.

In another example of the present invention, a method for making a non-naturally occurring carbohydrate-based fibrous element, the method comprises the step of spinning a fibrous element from a composition comprising a carbohydrate derivative such that the fibrous element produced comprises a macrostructure and a microstructure, wherein the microstructure is visible when wet as determined by the Microstructure Detection Test Method, is provided.

Accordingly, the present invention provides a non-naturally occurring, wettable carbohydrate-based fibrous element and a method for making the same.

### BRIEF DESCRIPTION OF THE DRAWINGS

FIG. 1 is a microphotograph of an example of a dry non-naturally occurring, wettable carbohydrate-based fibrous element according to the present invention; and

FIG. 2 is a microphotograph of the fibrous element of FIG. 1 when wet.

### DETAILED DESCRIPTION OF THE INVENTION

### Definitions

“Non-naturally occurring” as used herein with respect to “non-naturally occurring fiber” means that the fiber is not found in nature in that form. In other words, some chemical processing of materials needs to occur in order to obtain the non-naturally occurring fiber. For example, a wood pulp fiber is a naturally occurring fiber, however, if the wood pulp fiber is chemically processed, such as via a lyocell-type process, a solution of cellulose is formed. The solution of cellulose may then be spun into a fiber. Accordingly, this spun fiber would be considered to be a non-naturally occurring fiber since it is not directly obtainable from nature in its present form.

“Carbohydrate-based” with reference to a fibrous element and/or material means that the fibrous element and/or material comprises a carbohydrate and/or carbohydrate derivative. In one example, carbohydrate-based means that the fibrous element and/or material comprises greater than about 30% and/or greater than about 40% and/or greater than about 50% and/or less than about 100% and/or less than about 90% and/or less than about 80% by weight of the fibrous element and/or material of the carbohydrate and/or carbohydrate derivative.

“Carbohydrate derivative” as used herein means a carbohydrate wherein one or more the of the hydroxyl groups on a pure carbohydrate have been chemically modified and/or replaced with a moiety other than merely —OH (a non-hydroxyl moiety), such as a hydroxyalkyl moiety, an ether moiety and/or an ester moiety.

“Polysaccharide” as used herein means a polymer comprising a plurality of monosaccharides (sugar units), typically pentose and/or hexose sugar units. Non-limiting examples of suitable polysaccharides include, but are not limited to, starches, celluloses, hemicelluloses, xylans, gums, arabinans, galactans and mixtures thereof. The term “polysaccharide” is also meant to include polymers with heteroatoms present in the polysaccharide structure, such as chitin and/or chitosan.

“Polysaccharide derivative” as used herein means that one or more of the original hydroxyl moieties (—OH) present on one or more monomer units (sugar units) of a pure polysaccharide has been chemically modified and/or replaced with a moiety other than merely —OH (a non-hydroxyl moiety), such as a hydroxyalkyl moiety, an ether moiety and/or an ester moiety. In one example, the polysaccharide derivative exhibits a weight average molecular weight of less than 1,000,000 g/mol and/or less than 800,000 g/mol and/or less than 600,000 g/mol and/or less than 400,000 g/mol to about 500 g/mol and/or to about 1,000 g/mol and/or to about 5,000 g/mol. In one example, the polysaccharide derivative comprises a starch derivative.

“Molar substitution” or “MS” as used herein means the average number of moles of hydroxyalkyl moiety per mole of monomer (sugar) unit.

“Thermoplastic” as used herein means, with respect to a material, such as a heteropolysaccharide derivative, that the material satisfies the Film-Forming Method described herein.

A “fibrous structure” as used herein means a single web structure that comprises at least one hemicellulose fiber. For example, a fibrous structure of the present invention may comprise one or more fibers, wherein at least one of the fibers comprises a hemicellulose fiber, such as a non-naturally occurring hemicellulose fiber. In another example, a fibrous structure of the present invention may comprise a plurality of fibers, wherein at least one (sometimes a majority, even all) of the fibers comprises a hemicellulose fiber, such as a non-naturally occurring hemicellulose fiber. The fibrous structures of the present invention may be layered such that one layer of the fibrous structure may comprise a different composition of fibers and/or materials from another layer of the same fibrous structure.

“Fibrous element” as used herein means an elongate particulate having a length greatly exceeding its average diameter, i.e. a length to average diameter ratio of at least about 10. A fibrous element may be a filament or a fiber. In one example, the fibrous element is a single fibrous element rather than a yarn comprising a plurality of fibrous elements.

The fibrous elements of the present invention may be spun from polymer melt compositions via suitable spinning operations, such as meltblowing and/or spunbonding and/or they may be obtained from natural sources such as vegetative sources, for example trees.

The fibrous elements of the present invention may be monocomponent and/or multicomponent. For example, the fibrous elements may comprise bicomponent fibers and/or filaments. The bicomponent fibers and/or filaments may be in any form, such as side-by-side, core and sheath, islands-in-the-sea and the like.

“Filament” as used herein means an elongate particulate as described above that exhibits a length of greater than or equal to 5.08 cm (2 in.) and/or greater than or equal to 7.62 cm (3 in.) and/or greater than or equal to 10.16 cm (4 in.) and/or greater than or equal to 15.24 cm (6 in.).

Filaments are typically considered continuous or substantially continuous in nature. Filaments are relatively longer than fibers. Non-limiting examples of filaments include meltblown and/or spunbond filaments. Non-limiting examples of polymers that can be spun into filaments include natural polymers, such as starch, starch derivatives, cellulose, such as rayon and/or lyocell, and cellulose derivatives, hemicellulose, hemicellulose derivatives, and synthetic polymers including, but not limited to thermoplastic polymer filaments, such as polyesters, nylons, polyolefins such as polypropylene filaments, polyethylene filaments, and biodegradable thermoplastic fibers such as polylactic acid filaments, polyhydroxyalkanoate filaments, polyesteramide filaments and polycaprolactone filaments.

“Fiber” as used herein means an elongate particulate as described above that exhibits a length of less than 5.08 cm (2 in.) and/or less than 3.81 cm (1.5 in.) and/or less than 2.54 cm (1 in.).

Fibers are typically considered discontinuous in nature. Non-limiting examples of fibers include pulp fibers, such as wood pulp fibers, and synthetic staple fibers such as polypropylene, polyethylene, polyester, copolymers thereof, rayon, glass fibers and polyvinyl alcohol fibers.

Staple fibers may be produced by spinning a filament tow and then cutting the tow into segments of less than 5.08 cm (2 in.) thus producing fibers.

In one example of the present invention, a fiber may be a naturally occurring fiber, which means it is obtained from a naturally occurring source, such as a vegetative source, for example a tree and/or plant. Such fibers are typically used in papermaking and are oftentimes referred to as papermaking fibers. Papermaking fibers useful in the present invention include cellulosic fibers commonly known as wood pulp fibers. Applicable wood pulps include chemical pulps, such as Kraft, sulfite, and sulfate pulps, as well as mechanical pulps including, for example, groundwood, thermomechanical pulp and chemically modified thermomechanical pulp. Chemical pulps, however, may be preferred since they impart a superior tactile sense of softness to tissue sheets made therefrom. Pulps derived from both deciduous trees (hereinafter, also referred to as “hardwood”) and coniferous trees (hereinafter, also referred to as “softwood”) may be utilized. The hardwood and softwood fibers can be blended, or alternatively, can be deposited in layers to provide a stratified web. Also applicable to the present invention are fibers derived from recycled paper, which may contain any or all of the above categories of fibers as well as other non-fibrous polymers such as fillers, softening agents, wet and dry strength agents, and adhesives used to facilitate the original papermaking.

In addition to the various wood pulp fibers, other cellulosic fibers such as cotton linters, rayon, lyocell and bagasse fibers can be used in the fibrous structures of the present invention.

“Sanitary tissue product” as used herein means a soft, low density (i.e. < about 0.15 g/cm3) fibrous structure useful as a wiping implement for post-urinary and post-bowel movement cleaning (toilet tissue), for otorhinolaryngological discharges (facial tissue), and multi-functional absorbent and cleaning uses (absorbent towels). The sanitary tissue product may be convolutedly wound upon itself about a core or without a core to form a sanitary tissue product roll.

In one example, the sanitary tissue product of the present invention comprises one or more fibrous structures according to the present invention.

The sanitary tissue products of the present invention may exhibit a basis weight between about 10 g/m² to about 120 g/m² and/or from about 15 g/m² to about 110 g/m² and/or from about 20 g/m² to about 100 g/m² and/or from about 30 to 90 g/m². In addition, the sanitary tissue product of the present invention may exhibit a basis weight between about 40 g/m² to about 120 g/m² and/or from about 50 g/m² to about 110 g/m² and/or from about 55 g/m² to about 105 g/m² and/or from about 60 to 100 g/m².

The sanitary tissue products of the present invention may exhibit a total dry tensile strength of greater than about 59 g/cm (150 g/in) and/or from about 78 g/cm (200 g/in) to about 394 g/cm (1000 g/in) and/or from about 98 g/cm (250 g/in) to about 335 g/cm (850 g/in). In addition, the sanitary tissue product of the present invention may exhibit a total dry tensile strength of greater than about 196 g/cm (500 g/in) and/or from about 196 g/cm (500 g/in) to about 394 g/cm (1000 g/in) and/or from about 216 g/cm (550 g/in) to about 335 g/cm (850 g/in) and/or from about 236 g/cm (600 g/in) to about 315 g/cm (800 g/in). In one example, the sanitary tissue product exhibits a total dry tensile strength of less than about 394 g/cm (1000 g/in) and/or less than about 335 g/cm (850 g/in).

In another example, the sanitary tissue products of the present invention may exhibit a total dry tensile strength of greater than about 500 g/in and/or greater than about 600 g/in and/or greater than about 700 g/in and/or greater than about 800 g/in and/or greater than about (900 g/in) and/or greater than about 394 g/cm (1000 g/in) and/or from about 315 g/cm (800 g/in) to about 1968 g/cm (5000 g/in) and/or from about 354 g/cm (900 g/in) to about 1181 g/cm (3000 g/in) and/or from about 354 g/cm (900 g/in) to about 984 g/cm (2500 g/in) and/or from about 394 g/cm (1000 g/in) to about 787 g/cm (2000 g/in).

The sanitary tissue products of the present invention may exhibit an initial total wet tensile strength of less than about 78 g/cm (200 g/in) and/or less than about 59 g/cm (150 g/in) and/or less than about 39 g/cm (100 g/in) and/or less than about 29 g/cm (75 g/in).

The sanitary tissue products of the present invention may exhibit an initial total wet tensile strength of greater than about 118 g/cm (300 g/in) and/or greater than about 157 g/cm (400 g/in) and/or greater than about 196 g/cm (500 g/in) and/or greater than about 236 g/cm (600 g/in) and/or greater than about 276 g/cm (700 g/in) and/or greater than about 315 g/cm (800 g/in) and/or greater than about 354 g/cm (900 g/in) and/or greater than about 394 g/cm (1000 g/in) and/or from about 118 g/cm (300 g/in) to about 1968 g/cm (5000 g/in) and/or from about 157 g/cm (400 g/in) to about 1181 g/cm (3000 g/in) and/or from about 196 g/cm (500 g/in) to about 984 g/cm (2500 g/in) and/or from about 196 g/cm (500 g/in) to about 787 g/cm (2000 g/in) and/or from about 196 g/cm (500 g/in) to about 591 g/cm (1500 g/in).

The sanitary tissue products of the present invention may exhibit a density of less than about 0.60 g/cm³ and/or less than about 0.30 g/cm³ and/or less than about 0.20 g/cm³ and/or less than about 0.10 g/cm³ and/or less than about 0.07 g/cm³ and/or less than about 0.05 g/cm³ and/or from about 0.01 g/cm³ to about 0.20 g/cm³ and/or from about 0.02 g/cm³ to about 0.10 g/cm³.

The sanitary tissue products of the present invention may exhibit a total absorptive capacity of according to the Horizontal Full Sheet (HFS) Test Method described herein of greater than about 10 g/g and/or greater than about 12 g/g and/or greater than about 15 g/g and/or from about 15 g/g to about 50 g/g and/or to about 40 g/g and/or to about 30 g/g.

The sanitary tissue products of the present invention may exhibit a Vertical Full Sheet (VFS) value as determined by the Vertical Full Sheet (VFS) Test Method described herein of greater than about 5 g/g and/or greater than about 7 g/g and/or greater than about 9 g/g and/or from about 9 g/g to about 30 g/g and/or to about 25 g/g and/or to about 20 g/g and/or to about 17 g/g.

The sanitary tissue products of the present invention may be in the form of sanitary tissue product rolls. Such sanitary tissue product rolls may comprise a plurality of connected, but perforated sheets of fibrous structure, that are separably dispensable from adjacent sheets.

The sanitary tissue products of the present invention may comprises additives such as softening agents, temporary wet strength agents, permanent wet strength agents, bulk softening agents, lotions, silicones, wetting agents, latexes, patterned latexes and other types of additives suitable for inclusion in and/or on sanitary tissue products.

In addition to sanitary tissue products, the fibrous structures of the present invention may be utilized in any number of various other applications known in the art. For example, in some examples, the fibrous structures may be utilized as packaging materials, wound dressings, etc.

“Wettable” as used herein with reference to a fibrous element and/or material means that the fibrous element and/or material exhibits a contact angle of less than about 80° and/or less than about 75° and/or less than about 70° and/or less than about 60° and/or less than about 50° and/or greater than about 25° and/or greater than about 30° and/or greater than about 35° and/or greater than about 40° measured using the Wilhelmy balance technique, which Augustine Scientific, Newbury, Ohio, can run on fibrous elements. In the Wilhelmy balance technique, an individual fibrous element is mounted vertically and is dipped into water. The force of water as a function of position as the fiber dips into the water is measured. The contact angle is calculated from the regressed force data and fiber diameter.

“Ply” or “Plies” as used herein means a single fibrous structure optionally to be disposed in a substantially contiguous, face-to-face relationship with other plies, forming a multi-ply sanitary tissue product. It is also contemplated that a single fibrous structure can effectively form two “plies” or multiple “plies”, for example, by being folded on itself. Ply or plies can also exist as films.

“Weight average molecular weight” as used herein means the weight average molecular weight as determined using gel permeation chromatography according to the protocol found in Colloids and Surfaces A. Physico Chemical & Engineering Aspects, Vol. 162, 2000, pg. 107-121. Unless otherwise specified, all molecular weight values herein refer to the weight average molecular weight.

### Carbohydrate Derivative

In one example, the carbohydrate derivative of the present invention is a thermoplastic carbohydrate derivative. In another example, the carbohydrate derivative is a polysaccharide derivative. In another example, the polysaccharide derivative is a starch derivative.

The carbohydrate derivative may exhibit a contact angle, measured using the Wilhelmy balance technique, which Augustine Scientific, Newbury, Ohio, can run on fibrous elements, of less than about 80° and/or less than about 75° and/or less than about 70° and/or less than about 60° and/or less than about 50° and/or greater than about 25° and/or greater than about 30° and/or greater than about 35° and/or greater than about 40°.

One or more of the hydroxyl moieties present on an unsubstituted carbohydrate may be replaced with one or more hydroxyalkyl ether moieties to create a carbohydrate derivative comprising one or more hydroxyalkyl ether moieties.

In one example, the carbohydrate derivative may comprise one or more monosaccharide units having the formula:

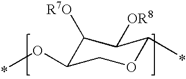

wherein R⁷ is independently selected from —H, —[CH₂CH(R⁹)O]ₘH, —[CH₂CH(CH₂OR¹⁰)O]ₙH and mixtures thereof, wherein R⁹ is independently selected from the group consisting of: linear or branched aliphatic group and mixtures thereof, wherein R¹⁰ is independently selected from the group consisting of: linear or branched aliphatic group and mixtures thereof, wherein each of m and n are at least 1; wherein R⁸ is independently selected from —H, —[CH₂CH(R¹¹)O]ₚH, —[CH₂CH(CH₂OR¹²)P]_{q}H and mixtures thereof, wherein R¹¹ is independently selected from the group consisting of: linear or branched aliphatic group and mixtures thereof, wherein R¹² is independently selected from the group consisting of: linear or branched aliphatic group and mixtures thereof, wherein each of p and q are at least 1; wherein the monosaccharide unit comprises at least one R⁷ and/or R⁸ that is not —H. R⁹ may be independently selected from the group consisting of: C₁-C₁₀ and/or C₂-C₄ linear or branched aliphatic groups and mixtures thereof. R¹⁰ may be independently selected from the group consisting of: C₁-C₁₄ and/or C₃-C₁₂ and/or C₆-C₁₀ linear or branched aliphatic groups and mixtures thereof. R¹¹ may be independently selected from the group consisting of: C₁-C₁₄ and/or C₁-C₁₀ and/or C₂-C₄ linear or branched aliphatic groups and mixtures thereof. R¹² may be independently selected from the group consisting of: C₁-C₁₄ and/or C₃-C₁₂ and/or C₆-C₁₀ linear or branched aliphatic groups and mixtures thereof. In one example, R⁷ and R⁸ may be the same.

In one example, the carbohydrate derivative may exhibit a weight average molecular weight of from about 10,000 g/mol to about 1,000,000 g/mol and/or greater than about 10,000 g/mol and/or greater than about 20,000 g/mol and/or greater than about 30,000 g/mol and/or greater than about 50,000 g/mol and/or to about 1,000,000 g/mol and/or to about 750,000 and/or to about 500,000 g/mol and/or to about 400,000 g/mol and/or to about 300,000 g/mol and/or to about 250,000 g/mol and/or to about 200,000 g/mol and/or to about 180,000 g/mol and/or to about 160,000 g/mol. In one example, the carbohydrate derivative exhibits a weight average molecular weight of from about 10,000 to about 500,000 g/mol.

The carbohydrate derivative may exhibit a Tg of less than about 200° C. and/or less than about 160° C. and/or less than about 150° C. and/or less than about 140° C. and/or less than about 125° C. and/or less than about 100° C. as measured according to the DSC Test Method described herein. In one example, the carbohydrate derivative exhibits a Tg that varies with moisture level.

### Source of Carbohydrate Derivative

The carbohydrate derivative of the present invention may be derived from a non-wood source. The non-wood source may comprise an agricultural byproduct. Non-limiting examples of suitable agricultural byproducts may be selected from the group consisting of: corn hulls, corn bran, corn fiber, corn stalks, corn cobs, sugar beet pulp, soybean hulls, wheat bran, wheat straw, distiller's grain, oat spelts and mixtures thereof. Other non-wood sources include algae, such as green algae, grasses, bast fibers and mixtures thereof.

In addition and/or alternatively, the carbohydrate derivative of the present invention may be derived from a wood source. Non-limiting examples of wood sources include wood pulp, such as softwood pulp such as NSK (Northern Softwood Kraft) pulp and/or SSK (Southern Softwood Kraft) pulp, and hardwood pulp, such as eucalyptus pulp and/or acacia pulp.

### Non-Naturally Occurring Fibrous Element

The carbohydrate derivative may be formed into an article, such as a film, foam, fibrous element, particle and mixtures thereof. In one example, the article may comprise at least about 10% and/or at least about 20% and/or at least about 30% and/or to about 100% and/or to about 95% and/or to about 90% and/or to about 70% by weight of the carbohydrate derivative.

The article may further comprise a hydrophilizing agent (wetting agent).

In one example, the article of the present invention may exhibit a contact angle of less than about 80° measured using the Wilhelmy balance technique, which Augustine Scientific, Newbury, Ohio, can run on fibrous elements.

### Method for Making Carbohydrate Derivative

The carbohydrate derivative of the present invention may be made by a method comprising the step of reacting a heteropolysaccharide, such as a hemicellulose, with a 1,2-epoxy compound having the formula:

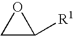

wherein R¹ is independently selected from the group consisting of: C₆ or greater linear or branched aliphatic groups, —CH₂OR² wherein R² is independently selected from the group consisting of: C₆ or greater linear or branched aliphatic groups and mixtures thereof. In one example, the 1,2-epoxy compound is selected from the group consisting of: a 1,2-epoxyhexane, n-hexylglycidyl ether, 2-ethylhexyl glycidyl ether, n-octylglycidyl ether, n-decylglycidyl ether and mixtures thereof.

In one example, this reaction step occurs at a pH of from about 12.3 to about 13.

In another example of the present invention, the carbohydrate derivative of the present invention may be made by a method comprising the step of reacting a carbohydrate, such as a polysaccharide, for example a starch, with a first 1,2-epoxy compound having the formula:

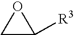

wherein R³ is independently selected from the group consisting of: H, C₁ to C₄ aliphatic groups, —CH₂OR⁴ wherein R⁴ is independently selected from the group consisting of: C₁ to C₄ aliphatic groups and mixtures thereof; and a second 1,2-epoxy compound having the formula:

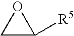

wherein R⁵ is independently selected from the group consisting of: C₆ or greater linear or branched aliphatic groups, —CH₂OR⁶ wherein R⁶ is independently selected from the group consisting of: C₆ or greater linear or branched aliphatic groups and mixtures thereof.

In one example, this first reaction step occurs at a pH of from about 11.5 to about 12.5 and the second reaction step occurs at a pH of from about 12.3 to about 13.

The first 1,2-epoxy compound may be selected from the group consisting of: ethylene oxide, propylene oxide, 1,2-epoxybutane, n-butylglycidyl ether and mixtures thereof.

The second 1,2-epoxy compound may be selected from the group consisting of: 1,2-epoxyhexane, n-hexylglycidyl ether, 2-ethylhexyl glycidyl ether, n-octylglycidyl ether, n-decylglycidyl ether and mixtures thereof.

In another example, a carbohydrate derivative according to the present invention may be produced by first producing a water soluble derivative such as that provided by reacting a carbohydrate with bromoacetic acid to produce a carboxymethyl derivative. The carboxymethyl derivative may then be further reacted with a 1,2-epoxy compound having the formula described above for the second 1,2 epoxy compound.

In one example, the method of the present invention further comprises the step of crosslinking the carbohydrate derivative.

### Method for Making a Fibrous Element

A non-limiting example of a method for making a non-naturally occurring carbohydrate-based fibrous element according to the present invention comprises the step of spinning a fibrous element from a composition comprising a carbohydrate derivative such that the fibrous element produced comprises a macrostructure and a microstructure, wherein the microstructure is visible when wet as determined by the Microstructure Detection Test Method. In one example, the microstructure exhibits an aspect ratio of greater than 2:1 and/or greater than 3:1 and/or greater than 4:1. In another example, the microstructure is axially aligned within the macrostructure along its length axis. In yet another example, the microstructure is randomly distributed within the macrostructure.

In one example, the carbohydrate derivative may be made by reacting a carbohydrate with a 1,2-epoxy compound having the formula:

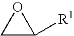

wherein R¹ is independently selected from the group consisting of: linear or branched aliphatic groups, —CH₂OR² wherein R² is independently selected from the group consisting of: linear or branched aliphatic groups and mixtures thereof. R¹ may be independently selected from the group consisting of: C₆ or greater linear or branched aliphatic groups, —CH₂OR² wherein R² is independently selected from the group consisting of: C₆ or greater linear or branched aliphatic groups and mixtures thereof.

In another example, the carbohydrate derivative may be made by reacting a carbohydrate with a first 1,2-epoxy compound having the formula:

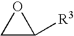

wherein R³ is independently selected from the group consisting of: H, C₁ to C₄ aliphatic groups, —CH₂OR⁴ wherein R⁴ is independently selected from the group consisting of: C₁ to C₄ aliphatic groups and mixtures thereof and a second 1,2-epoxy compound having the formula:

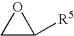

wherein R⁵ is independently selected from the group consisting of: C₆ or greater linear or branched aliphatic groups, —CH₂OR⁶ wherein R⁶ is independently selected from the group consisting of: C₆ or greater linear or branched aliphatic groups and mixtures thereof. The first 1,2-epoxy compound may be selected from the group consisting of: ethylene oxide, propylene oxide, 1,2-epoxybutane, n-butylglycidyl ether and mixtures thereof. The second 1,2-epoxy compound may be selected from the group consisting of: 1,2-epoxyhexane, n-hexylglycidyl ether, 2-ethylhexyl glycidyl ether, n-octylglycidyl ether, n-decylglycidyl ether and mixtures thereof.

Spinning process temperatures for the carbohydrate-based composition can range from about 105° C. to about 300° C., and in some embodiments can be from about 130° C. to about 230° C. and/or from about 150° C. to about 210° C. and/or from about 150° C. to about 190° C. The spinning processing temperature is determined by the chemical nature, molecular weights and concentration of each component.

In one example, fiber spinning speeds for spinning the non-naturally occurring carbohydrate-based fibrous elements may be greater than about 5 m/min and/or greater than about 7 m/min and/or greater than about 10 m/min and/or greater than about 20 m/min. In another example, the fiber spinning speeds may be from about 100 to about 7,000 m/min and/or from about 300 to about 3,000 m/min and/or from about 500 to about 2,000 m/min.

The non-naturally occurring carbohydrate-based fibrous element may be made by fiber spinning processes characterized by a high draw down ratio. The draw down ratio is defined as the ratio of the fibrous element at its maximum diameter (which is typically occurs immediately after exiting the capillary of the spinnerette in a conventional spinning process) to the final diameter of the formed fibrous element. The fiber draw down ratio via either spunbond, or meltblown process will typically be 1.5 or greater, and can be about 5 or greater, about 10 or greater, or about 12 or greater.

In the process of spinning fibrous elements, particularly as the temperature is increased above 105° C., residual water levels may be less than about 1% and/or less than about 0.5% and/or less than about 0.15% by weight of the fibrous element.

The spinnerette capillary dimensions can vary depending upon desired fibrous element size and design, spinning conditions, and polymer properties. Suitable capillary dimensions include, but are not limited to, length-to-diameter ratio of 4 with a diameter of 0.35 mm.

In one example, the amount of carbohydrate-based composition flowing through the spinnerette and being spun into fibrous elements may be from at least about 0.1 grams/hole/minute (g/h/m) and/or from about 0.1 g/h/m to about 20 g/h/m and/or from about 0.1 g/h/m to about 15 g/h/m and/or from about 0.2 g/h/m to about 10 g/h/m and/or from about 0.2 g/h/m to about 8 g/h/m.

The residence time of the carbohydrate-based composition in the spinnerette and/or extruder can be varied so as to not degrade the carbohydrate and/or carbohydrate derivative. For example, if it is desired to add a high melting temperature thermoplastic polymer to the carbohydrate-based composition before spinning, then the high melting temperature thermoplastic polymer may be subjected to a temperature for an amount of time in the absence of the carbohydrate and/or carbohydrate derivative. The carbohydrate and/or carbohydrate derivative may then be added immediately before spinning of the carbohydrate-based composition into a fibrous element.

### Non-Limiting Synthesis Examples of Carbohydrate-Based Fibrous Elements

### Example 1

Starch (Clinton 290) powder (60.0 g) obtained from Archer-Daniels-Midland of Iowa is added in portions to 400 mL of water in a 1 L beaker on a hot plate/stirrer. The mixture is stirred with heating (60-70° C.) until all of the starch is dissolved. Sodium sulfate (5. g) is added and the solution is cooled to room temperature (23.3° C.±4° C.) and then adjusted to pH 11.5 with 25% NaOH. The solution is then transferred to a glass flask, a 1 L Parr 51111 Low Pressure Reactor Vessel commercially available from Parr Instrument Company. 1,2-Epoxybutane (50 mL) is then added to the glass flask. The glass flask is then sealed onto a stainless steel head with a clamp. The head is fitted with a multi-blade impeller, cooling loop, pressure relief valves and a gas inlet port. The solution is stirred for 4 hours at 80° C. and 20 psi. After cooling to room temperature, the glass flask is removed from the reactor. A small aliquot of the solution is added to acetone to precipitate an analytical sample of the product; namely, a hydroxybutyl starch. The MS of the hydroxybutyl starch derivative is 0.36 as measured by ¹H-NMR spectroscopy (300 MHz, DMSO-d₆).

The remaining solution in the glass flask is adjusted to pH 13.0 with 25% NaOH. 2-Ethylhexyl glycidyl ether (75 mL) is added to the glass flask and sealed to the Parr Reactor head again. The mixture is stirred for 4 hours at 125° C. and 45 psi. During this time, a solid precipitated from the reaction mixture. After cooling to room temperature, the solid is collected by suction filtration, washed with 1 L of distilled water and then dried in a vacuum oven to obtain 134.8 g of the solid product. This solid product is ground into a powder using a Wiley mill fitted with a 20 mesh screen and then washed with 500 mL of acetone. The resulting product (92.1 g) is a light brown solid. The MS of the 2-ethylhexyl glycerol ether moiety is 0.56 as measured by ¹H-NMR spectroscopy (300 MHz, DMSO-d₆). A fibrous element made from the resulting product exhibits a macrostructure and microstructure, which is visible when wet as determined by the Microstructure Detection Test Method described herein.

### Example 2

### Comparative Example

Starch (Clinton 290) powder (60.0 g) obtained from Archer-Daniels-Midland of Iowa is added in portions to 400 mL of water in a 1 L beaker on a hot plate/stirrer. The mixture is stirred with heating (60-70° C.) until all of the starch is dissolved. Sodium sulfate (5.0 g) is added and the solution is cooled to room temperature (23.3° C.±4° C.) and then adjusted to pH 12.3 with 25% NaOH. The solution is then transferred to a 1.5 L stainless steel jacketed pressure vessel. 1,2-Epoxyhexane (50 mL) is then added to the pressure vessel and the solution is heated at 110° C. for four hours at 30 psi. After cooling to room temperature, the solid that is precipitated is collected by suction filtration, washed with 1 L of distilled water and then dried in a vacuum oven at 50° C. This solid product is ground into a powder using a Wiley mill fitted with a 20 mesh screen and then washed with 500 mL of ethyl acetate and dried in a vacuum oven. The resulting product (72.2 g) is a light brown solid hydroxyhexyl starch. A fibrous element made from the resulting product fails to exhibit a macrostructure and microstructure, which is visible when wet as determined by the Microstructure Detection Test Method described herein.

### Test Methods

Unless otherwise indicated, all tests described herein including those described under the Definitions section and the following test methods are conducted on samples, test equipment and test surfaces that have been conditioned in a conditioned room at a temperature of 73° F.±4° F. (about 23° C.±2.2° C.) and a relative humidity of 50%±10% for 12 hours prior to the test. Further, all tests are conducted in such conditioned room.

### Microstructure Detection Test Method

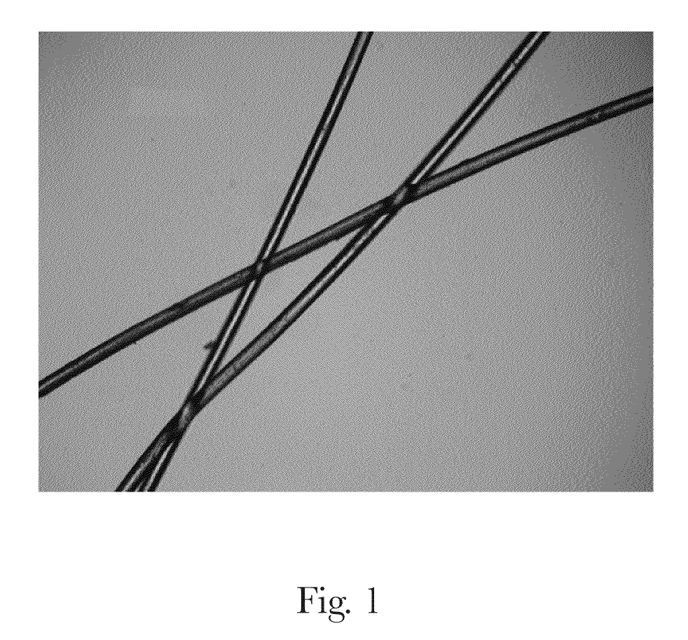

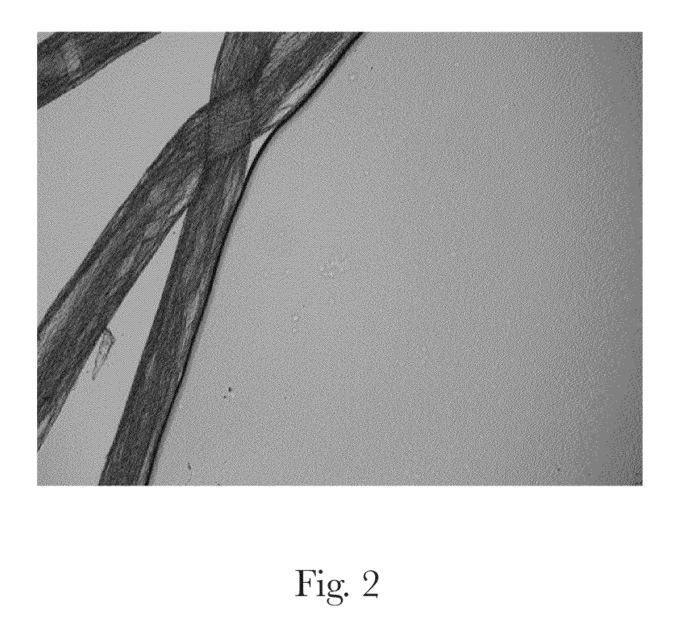

An individual fibrous element is placed on a glass microscope slide (VWR VistaVision) under cover glass (Corning Cover Glass No. 1, 25 mm²). A Nikon Eclipse E800 Light microscope is used for the microscopic examination (10×, 20× objectives) and imaging (Photometric CoolSnap cf camera mounted on a Nikon TV C-0.45× lens) of the fibrous element, both dry and wet. The dry fiber diameter of the fibrous element is measured using a standard eye piece reticle calibrated using an N.I.S.T. #821/273087-06 scale. Images of the dry fibrous element are captured. The cover glass is then removed and the dry fibrous element is then wetted using a general transfer polyethylene disposable pipette capable of delivering 20 drops per ml with 3-5 drops of tap water. The cover glass is then put back on the wetted fibrous element. The wet fibrous element diameters are then measured immediately. Subsequent images of the wet fibrous element are captured at one minute intervals for 30 minutes to observe, capture and measure the impact of water on the fiber. The collected images are converted to an .avi file for viewing using Metamorph Software (Meta Imaging Series 6.1, by Molecular Devices Corp.). FIG. 1 is an image of a dry fibrous element. FIG. 2 is an image of the same fibrous element after wetting according to this test method.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A non-naturally occurring, wettable carbohydrate-based fibrous element comprising a macrostructure and a microstructure, wherein the microstructure is visible when wet as determined by the Microstructure Detection Test Method.

2. The non-naturally occurring carbohydrate-based fibrous element according to claim 1 wherein the non-naturally occurring carbohydrate-based fibrous element comprises a carbohydrate derivative.

3. The non-naturally occurring carbohydrate-based fibrous element according to claim 2 wherein the carbohydrate derivative comprises a polysaccharide derivative.

4. The non-naturally occurring carbohydrate-based fibrous element according to claim 3 wherein the polysaccharide is selected from the group consisting of: cellulose derivatives, starch derivatives, hemicellulose derivatives, chitin derivatives, chitosan derivatives and mixtures thereof.

5. The non-naturally occurring carbohydrate-based fibrous element according to claim 3 wherein the polysaccharide derivative is derived from a non-wood source.

6. The non-naturally occurring carbohydrate-based fibrous element according to claim 3 wherein the polysaccharide derivative is a starch derivative.

7. The non-naturally occurring carbohydrate-based fibrous element according to claim 3 wherein the non-wood source comprises an agricultural byproduct.

8. The non-naturally occurring carbohydrate-based fibrous element according to claim 7 wherein the agricultural byproduct is selected from the group consisting of: corn hulls, corn bran, corn fiber, corn stalks, corn cobs, sugar beet pulp, soybean hulls, wheat bran, wheat straw, distiller's grain, oat spelts and mixtures thereof.

9. The non-naturally occurring carbohydrate-based fibrous element according to claim 3 wherein the polysaccharide derivative is derived from a wood source.

10. The non-naturally occurring carbohydrate-based fibrous element according to claim 2 wherein the carbohydrate derivative exhibits a weight average molecular weight of from about 10,000 to about 1,000,000 g/mol.

11. The non-naturally occurring carbohydrate-based fibrous element according to claim 2 wherein the carbohydrate derivative comprises one or more hydroxyalkyl ether moieties.

12. The non-naturally occurring carbohydrate-based fibrous element according to claim 2 wherein the carbohydrate derivative comprises one or more monosaccharide units having the formula: 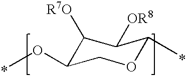
wherein R⁷ is independently selected from —H, —[CH₂CH(R⁹)O]ₘH, —[CH₂CH(CH₂OR¹⁰)O]ₙH and mixtures thereof, wherein R⁹ is independently selected from the group consisting of: linear or branched aliphatic group and mixtures thereof, wherein R¹⁰ is independently selected from the group consisting of: linear or branched aliphatic group and mixtures thereof, wherein each of m and n are at least 1; wherein R⁸ is independently selected from —H, —[CH₂CH(R¹¹)O]ₚH, —[CH₂CH(CH₂OR¹²)O]_{q}H and mixtures thereof, wherein R¹¹ is independently selected from the group consisting of: linear or branched aliphatic group and mixtures thereof, wherein R¹² is independently selected from the group consisting of: linear or branched aliphatic group and mixtures thereof, wherein each of p and q are at least 1; wherein the monosaccharide unit comprises at least one R⁷ and/or R⁸ that is not —H.

13. The non-naturally occurring carbohydrate-based fibrous element according to claim 12 wherein R⁹ is independently selected from the group consisting of: C₁-C₁₀ linear or branched aliphatic groups.

14. The non-naturally occurring carbohydrate-based fibrous element according to claim 13 wherein R⁹ is independently selected from the group consisting of: C₂-C₄ linear or branched aliphatic groups.

15. The non-naturally occurring carbohydrate-based fibrous element according to claim 12 wherein R¹⁰ is independently selected from the group consisting of: C₁-C₁₄ linear or branched aliphatic groups and mixtures thereof.

16. The non-naturally occurring carbohydrate-based fibrous element according to claim 15 wherein R¹⁰ is independently selected from the group consisting of: C₃-C₁₂ linear or branched aliphatic groups.

17. The non-naturally occurring carbohydrate-based fibrous element according to claim 16 wherein R¹⁰ is independently selected from the group consisting of: C₆-C₁₀ linear or branched aliphatic groups.

18. The non-naturally occurring carbohydrate-based fibrous element according to claim 1 wherein the microstructure exhibits an aspect ratio of greater than 2:1

19. The non-naturally occurring carbohydrate-based fibrous element according to claim 1 wherein the microstructure is axially aligned within the macrostructure along its length axis.

20. The non-naturally occurring carbohydrate-based fibrous element according to claim 1 wherein the microstructure is randomly distributed within the macrostructure.

21. A method for making a non-naturally occurring carbohydrate-based fibrous element, the method comprises the step of spinning a fibrous element from a composition comprising a carbohydrate derivative such that the fibrous element produced comprises a macrostructure and a microstructure, wherein the microstructure is visible when wet as determined by the Microstructure Detection Test Method.

22. The method according to claim 21 wherein the carbohydrate derivative is made by reacting a carbohydrate with a 1,2-epoxy compound having the formula: 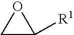
wherein R¹ is independently selected from the group consisting of: linear or branched aliphatic groups, —CH₂OR² wherein R² is independently selected from the group consisting of: linear or branched aliphatic groups and mixtures thereof.

23. The method according to claim 22 wherein R¹ is independently selected from the group consisting of: C₆ or greater linear or branched aliphatic groups, —CH₂OR² wherein R² is independently selected from the group consisting of: C₆ or greater linear or branched aliphatic groups and mixtures thereof.

24. The method according to claim 21 wherein the carbohydrate derivative is made by reacting a carbohydrate with a first 1,2-epoxy compound having the formula: 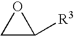
wherein R³ is independently selected from the group consisting of: H, C₁ to C₄ aliphatic groups, —CH₂OR⁴ wherein R⁴ is independently selected from the group consisting of: C₁ to C₄ aliphatic groups and mixtures thereof and a second 1,2-epoxy compound having the formula: 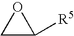
wherein R⁵ is independently selected from the group consisting of: C₆ or greater linear or branched aliphatic groups, —CH₂OR⁶ wherein R⁶ is independently selected from the group consisting of: C₆ or greater linear or branched aliphatic groups and mixtures thereof such that a carbohydrate derivative is produced.

25. The method according to claim 24 wherein the first 1,2-epoxy compound is selected from the group consisting of: ethylene oxide, propylene oxide, 1,2-epoxybutane, n-butylglycidyl ether and mixtures thereof.

26. The method according to claim 24 wherein the second 1,2-epoxy compound is selected from the group consisting of: 1,2-epoxyhexane, n-hexylglycidyl ether, 2-ethylhexyl glycidyl ether, n-octylglycidyl ether, n-decylglycidyl ether and mixtures thereof.
